(19) United States
(12) Patent Application Publication
(10) Pub. No.: US 2023/0265272 A1
(43) Pub. Date: Aug. 24, 2023

(54) HIGH FLOW HETEROPHASIC POLYPROPYLENE AS APPEARANCE IMPROVER IN POLYOLEFIN COMPOSITIONS

(71) Applicant: Basell Poliolefine Italia S.r.l., Milan (IT)

(72) Inventors: Claudio Cavalieri, Ferrara (IT); Mikhail Dureev, Butzbach (DE); Michele Grazzi, Ferrara (IT)

(73) Assignee: Basell Poliolefine Italia S.r.l., Milan (IT)

(21) Appl. No.: 18/015,933

(22) PCT Filed: Jul. 1, 2021
(86) PCT No.: PCT/EP2021/068169

§ 371 Date: Jan. 12, 2023

(30) Foreign Application Priority Data
Jul. 21, 2020 (EP) 20186844.5

(51) Int. Cl. C08L 23/14

(52) U.S. Cl. CPC C08L 23/142; C08L 2205/025

(57) ABSTRACT

Heterophasic copolymers of propylene having a MFR₂ (230° C./2.16 Kg) of from 3.0 to 12.0 g/10 min made from or containing:

(a) from 55 to 75 wt. % of a component (A) being a copolymer of propylene with ethylene or a C₄-C₁₀ alpha-olefin, made from or containing from 0.5 to 2.0 wt. % of ethylene and/or C₄-C₁₀ alpha-olefin units and having a MFR₂ (230° C./2.16 K g) ranging from 60 to 140 g/10 min; and
(b) from 25 to 45 wt. % of a component (B) being a propylene-ethylene copolymer made from or containing from 25 to 45 wt. % of ethylene units and having a value of the intrinsic viscosity of the fraction soluble in xylene at room temperature (XS-IV) ranging from 5 to 9 dl/g.

### FIELD OF THE INVENTION

In general, the present disclosure relates to the field of chemistry. More specifically, the present disclosure relates to polymer chemistry. In particular, the present disclosure relates to heterophasic copolymers of propylene and thermoplastic polyolefin compositions made therefrom.

### BACKGROUND OF THE INVENTION

In some instances, polypropylene and thermoplastic polyolefins are injection molded into a variety of articles, including for molded-in color applications.

In some instances, the injection molding technique for obtaining large parts such as automobile bumpers and fascia presents challenges such as cold flow, tiger striping, and gels. As used herein, the term “cold flow” refers to when a molten polymer, being injected into a mold, begins to cool and solidify before the mold is filled completely with the polymer. As used herein, the term “tiger striping” refers to color and gloss variations on the surface of an injection molded article. It is believed that a molten polymer's unstable mold filling properties cause tiger striping as the molten polymer is injected into a mold and formed into a shape.

### SUMMARY OF THE INVENTION

In a general embodiment, the present disclosure provides a heterophasic copolymer made from or containing:
(a) from 55 to 75 wt. %, based on the total weight of the heterophasic copolymer, of a component (A), wherein component (A) is a copolymer of: (1) propylene and (2) ethylene or an alpha-olefin having 4-10 carbon atoms, and wherein component (A) is made from or containing from 0.5 to 2.0 wt. %, based on the total weight of component (A), of units of ethylene and/or of C₄-C₁₀ alpha-olefin and has a MFR₂ (230° C./2.16 Kg) ranging from 60 to 140 g/10 min.; and
(b) from 25 to 45 wt. %, based on the total weight of the heterophasic copolymer, of a component (B), wherein component (B) is a propylene-ethylene copolymer, and wherein component (B) is made from or containing from 25 to 45 wt. %, based on the total weight of component (B), of ethylene units and contains a fraction that is soluble in xylene at room temperature, and wherein the fraction that is soluble in xylene at room temperature has an intrinsic viscosity (XS-IV) ranging from 5 to 9 dl/g; wherein the percentages of components (A) and (B) are referred to the sum of components (A) and (B) and wherein the sum of components (A) and (B) equals 100;
   wherein the heterophasic copolymer has a MFR₂ (230° C./2.16 Kg) ranging from 3.0 to 12.0 g/10 min.
   In some embodiments, the amount of component (A) ranges from 58 to 71 wt. %, based on the total weight of the heterophasic copolymer. In some embodiments, the comonomer of component (A) is butene-1. In some embodiments, the butene-1 content ranges from 1.0 to 1.5 wt. %, based on the total weight of component (A). In some embodiments, the MFR₂ (230° C./2.16 Kg) of component (A) ranges from 80 to 120 g/10 min.

In some embodiments, component (B) is present in an amount ranging from 29 to 42 wt. %, based on the total weight of the heterophasic copolymer. In some embodiments, the content of ethylene units in component (B) ranges from 28 to 35 wt. %, based on the total weight of component (B). In some embodiments, the intrinsic viscosity of the fraction soluble in xylene at room temperature (XS-IV) for component (B) ranges from 6 to 8 dl/g.

### DETAILED DESCRIPTION OF THE INVENTION

In some embodiments, the P.I. (Polydispersity Index) of component (A) is higher than 4, alternatively ranges from 4 to 10, alternatively from 5 to 9. As used herein, the term “polydispersity index” refers to the breath of the molecular weight distribution of component (A) measured according to the rheological method described in the characterization section. As used herein, values of P.I. higher than 4 are indicative of component (A) having a broad molecular weight distribution (MWD). In some embodiments, a broad MWD is obtained either by using a catalyst component to produce polymers with a broad MWD or by adopting processes for obtaining polymer fractions having different molecular weights. In some embodiments, the process is a polymerization in multiple steps under different conditions.

In some embodiments, the heterophasic copolymers have a value of Charpy impact resistance at 23° C. ranging from 40 to 100 KJ/m², alternatively from 45 to 90 KJ/m², alternatively from 50 to 85 KJ/m².

In some embodiments, the heterophasic copolymers have a Charpy impact resistance at −20° C. ranging from 3.0 to 5.0 KJ/m², alternatively from 3.5 to 4.5 KJ/m².

In some embodiments, the heterophasic copolymers are prepared by a sequential polymerization, including at least two sequential steps, wherein components (A) and (B) are prepared in separate subsequent steps, operating in each step, except the first step, in the presence of the polymer formed and the catalyst used in the preceding step. In some embodiments, the component (A) is prepared in one or more sequential steps.

In some embodiments, the component (A) is produced in one step and has a molecular weight distribution of monomodal type. In some embodiments, component (A) is produced in two or more steps. In some embodiments, the same polymerization conditions are maintained in the polymerization steps and component (A) has a molecular weight distribution of monomodal type. In some embodiments, the polymerization conditions are differentiated among the various polymerization steps and component (A) has a multimodal molecular weight distribution. In some embodiments, the polymerization conditions are differentiated by varying the amount of molecular weight regulator.

In some embodiments, the polymerization is continuous or batch. In some embodiments, the polymerization is carried out according to cascade techniques operating either in mixed liquid phase/gas phase or totally in gas phase. In some embodiments, the liquid phase polymerization is a slurry polymerization carried out in the presence of an inert solvent. In some embodiments, the liquid phase polymerization is a bulk polymerization, wherein the liquid medium is constituted by the liquid monomer. In some embodiments, the sequential polymerization stages are carried out in gas phase.

In some embodiments, a process, including at least two sequential fluidized-bed gas-phase polymerization steps, is used, wherein components (A) and (B) are prepared in separate subsequent steps, operating in each step, except the first step, in the presence of the polymer formed and the catalyst used in the preceding step. The propylene copolymer (A) is produced in one or more fluidized-bed gas-phase reactor(s). The resulting polymerization mixture is discharged to a gas-solid separator and subsequently fed to another fluidized-bed gas-phase reactor, wherein the propylene copolymer (B) is produced.

In some embodiments, the propylene copolymer (A) is produced by a gas-phase polymerization process carried out in at least two interconnected polymerization zones. In some embodiments, the polymerization process is as described in Patent Cooperation Treaty Publication Nos. WO 1997/004015 and WO 2002/051912. The process is carried out in a first interconnected polymerization zone and in a second interconnected polymerization zone, to which propylene and ethylene/alpha-olefins are fed in the presence of a catalyst system and from which the polymer produced is discharged. The growing polymer particles flow through the first of the polymerization zones (riser) under fast fluidization conditions, leave the first polymerization zone, enter the second of the polymerization zones (downcomer) through which the polymer particles flow in a densified form under the action of gravity, leave the second polymerization zone, and are reintroduced into the first polymerization zone, thereby establishing a circulation of polymer between the two polymerization zones. In the second stage, the polymerization mixture is discharged from the downcomer to a gas-solid separator and subsequently fed to a fluidized-bed gas-phase reactor, where the propylene copolymer (B) is produced.

In some embodiments, the polymerization of the propylene copolymer component (A) is carried out in liquid phase, using liquid propylene as diluent. In some embodiments, the copolymerization stage to obtain the propylene copolymer component (B) is carried out in gas phase. In some embodiments, there are no intermediate stages between the polymerization of the propylene copolymer component (A) and the copolymerization stage for propylene copolymer component (B), except for the partial degassing of the monomers.

In some embodiments, the temperature for the preparation of components (A) and (B) are the same or different. In some embodiments, the temperature is from 50° C. to 120° C. In some embodiments, the polymerization for the preparation of components (A) and (B) is carried out in gas-phase and the polymerization pressure ranges from 0.5 to 12 MPa. In some embodiments, the catalytic system is pre-contacted (pre-polymerized) with small amounts of olefins. In some embodiments, the molecular weight of the heterophasic copolymers is regulated. In some embodiments, the molecular weight regulator is hydrogen.

In some embodiments, components (A) and (B) are prepared in any order. In some embodiments, component (B) is produced after component (A) in a subsequent reactor.

In some embodiments, the heterophasic copolymers are obtained by (a) separately preparing the copolymers (A) and (B), operating with the same catalysts and under the same polymerization conditions as previously described herein, and (b) subsequently mechanically blending the copolymers in the molten state using mixing apparatuses, like twin-screw extruders.

In some embodiments, the polymerizations are carried out in the presence of stereospecific Ziegler-Natta catalysts. In some embodiments, the catalyst system used to prepare the heterophasic copolymers are made from or containing (A) a solid catalyst component made from or containing a titanium compound having at least one titanium-halogen bond, and an electron-donor compound, both supported on a magnesium halide and (B) an organo-aluminum compound, such as an aluminum alkyl compound, as a co-catalyst. An external electron donor compound as a further component (C) is optionally added.

In some embodiments, the catalysts produce polypropylene with an isotactic index greater than 90%, alternatively greater than 95%. In some embodiments, the catalysts systems areas described in the European Patent Nos. EP45977, EP361494, EP728769, and EP 1272533 and Patent Cooperation Treaty Publication No. WO00/63261.

In some embodiments, the solid catalyst components are made from or containing electron-donors (internal donors) compounds selected from the group consisting of ethers, ketones, and esters of mono- and dicarboxylic acids.

In some embodiments, the electron-donor compounds are phthalic acid esters. In some embodiments, the phthalic acid esters are selected from the group consisting of diisobutyl phthalate, dioctyl phthalate, diphenyl phthalate, and benzylbutyl phthalate.

In some embodiments, the electron-donor compounds are succinates. In some embodiments, the succinates have formula (I):

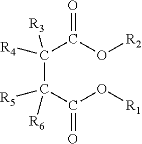

wherein the radicals R₁ and R₂, equal to, or different from, each other are a C₁-C₂₀ linear or branched alkyl, alkenyl, cycloalkyl, aryl, arylalkyl or alkylaryl group, optionally containing heteroatoms; the radicals R₃ to R₆ equal to, or different from, each other, are hydrogen or a C₁-C₂₀ linear or branched alkyl, alkenyl, cycloalkyl, aryl, arylalkyl or alkylaryl group, optionally containing heteroatoms. In some embodiments, the radicals R₃ to R₆ are joined to the same carbon atom and linked together to form a cycle. In some embodiments, R₃ to R₅ are contemporaneously hydrogen and R₆ is a radical selected from primary branched, secondary, or tertiary alkyl groups, cycloalkyl, aryl, arylalkyl or alkylaryl groups having from 3 to 20 carbon atoms, or a linear alkyl group having at least four carbon atoms optionally containing heteroatoms.

In some embodiments, the solid catalyst component is prepared by reacting a titanium compound of formula Ti(OR)_{n-y}X_{y}, where n is the valence of titanium and y is a number between 1 and n with a magnesium chloride deriving from an adduct of formula MgCl₂·pROH, where p is a number between 0.1 and 6, alternatively from 2 to 3.5, and R is a hydrocarbon radical having 1-18 carbon atoms. In some embodiments, the titanium compound is TiCl₄. In some embodiments, the adduct is prepared in spherical form by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. In some embodiments, the procedure for the preparation of the spherical adducts is as described in U.S. Pat. Nos. 4,399,054 and 4,469,648. In some embodiments, the resulting adduct is directly reacted with the Ti compound or subjected to thermal controlled dealcoholation (80-130° C.), thereby obtaining an adduct wherein the number of moles of alcohol is lower than 3, alternatively between 0.1 and 2.5. In some embodiments, the reaction with the Ti compound is carried out by suspending the adduct (dealcoholated or as such) in cold TiCl₄. In some embodiment, cold TiCl₄ is at 0° C. In some embodiments, the mixture is heated up to 80-130° C. and kept at this temperature for 0.5-2 hours. In some embodiments, the treatment with TiCl₄ is carried out one or more times. In some embodiments, the internal donor is added during the treatment with TiCl₄. In some embodiments, the treatment with the electron donor compound is repeated one or more times. In some embodiments, the internal electron donor is used in molar ratio with respect to the MgCl₂ of from 0.01 to 1, alternatively from 0.05 to 0.5. In some embodiments, the catalyst components are prepared in spherical form as described in European Patent Application No. EP-A-395083 and Patent Cooperation Treaty Publication No. WO98/44001. In some embodiments, the solid catalyst components have a surface area (by B.E.T. method) between 20 and 500 m²/g, alternatively between 50 and 400 m²/g, and a total porosity (by B.E.T. method) higher than 0.2 cm³/g, alternatively between 0.2 and 0.6 cm³/g. In some embodiments, the porosity (Hg method) due to pores with radius up to 10.000 Å ranges from 0.3 to 1.5 cm³/g, alternatively from 0.45 to 1 cm³/g.

In some embodiments, and in the solid catalyst component, the titanium compound, expressed as Ti, is present in an amount from 0.5 to 10% by weight. In some embodiments, the quantity of electron-donor compound which remains fixed on the solid catalyst component is 5 to 20% by moles with respect to the magnesium dihalide.

In some embodiments, the reactions yield a magnesium halide in active form. In some embodiments, magnesium halide in active form is yielded from reactions starting from magnesium compounds other than halides, such as magnesium carboxylates.

In some embodiments, the organo-aluminum compound is an alkyl-Al compound selected from the group consisting of trialkyl aluminum compounds, alkylaluminum halides, alkylaluminum hydrides, and alkylaluminum sesquichlorides. In some embodiments, the trialkyl aluminum compounds are selected from the group consisting of triethylaluminum, triisobutylaluminum, tri-n-butylaluminum, tri-n-hexylaluminum, and tri-n-octylaluminum. In some embodiments, the organo-aluminum compound is an alkylaluminum sesquichloride selected from the group consisting of AlEt₂Cl and Al₂Et₃Cl₃. In some embodiments, the organo-aluminum compound is a mixture including trialkylaluminums.

In some embodiments, the Al-alkyl compound is used in a quantity such that the Al/Ti ratio is from 1 to 1000.

In some embodiments, the external electron-donor compounds are selected from the group consisting of silicon compounds, ethers, esters, amines, heterocyclic compounds, ketones, and 1,3-diethers. In some embodiment, the ester is an ethyl 4-ethoxybenzoate. In some embodiments, the heterocyclic compound is 2,2,6,6-tetramethyl piperidine. In some embodiments, the external donor compounds are silicon compounds of formula Rₐ⁵R_{b}⁶Si(OR⁷)_{c}, where a and b are integer from 0 to 2, c is an integer from 1 to 3 and the sum (a+b+c) is 4; R⁵, R⁶, and R⁷ are alkyl, cycloalkyl or aryl radicals with 1-18 carbon atoms optionally containing heteroatoms. In some embodiments, the external donor compounds are selected from the group consisting of methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane, 1,1,1,trifluoropropyl-2-ethylpiperidinyl-dimethoxysilane, and 1,1,1,trifluoropropyl-metil-dimethoxysilane. In some embodiments, the external electron donor compound is used in an amount such that the molar ratio between the organo-aluminum compound and the electron donor compound is from 0.1 to 500.

In some embodiments, the heterophasic copolymers are further made from or containing additives. In some embodiments, the additives are selected from the group consisting of antioxidants, light stabilizers, heat stabilizers, colorants, and fillers.

In some embodiments, the heterophasic copolymers are compounded with additional polyolefins. In some embodiments, the additional polyolefins are selected from the group consisting of propylene polymers, random copolymers, and thermoplastic elastomeric polyolefin compositions. In some embodiments, the propylene polymers are propylene homopolymers.

In some embodiments, the present disclosure provides a thermoplastic polyolefin composition for injection molding made from or containing the heterophasic copolymers. In some embodiments, the thermoplastic polyolefin composition is made from or containing up to 30% by weight, alternatively from 8% to 25% by weight, alternatively from 10 to 20% by weight, of the heterophasic copolymer.

In some embodiments, the polyolefins to which the heterophasic copolymer is added are selected from the group consisting of:
1) crystalline propylene homopolymers;
2) crystalline propylene copolymers with ethylene and/or a C₄-C₁₀ α-olefin, wherein the total comonomer content ranges from 0.05 to 20% by weight with respect to the weight of the copolymer;
3) crystalline ethylene homopolymers and copolymers with propylene and/or a C₄-C₁₀ α-olefin;
4) elastomeric copolymers of ethylene with propylene and/or a C₄-C₁₀ α-olefins, optionally containing minor quantities of a diene; and
5) thermoplastic elastomeric polyolefin compositions made from or containing one or more of propylene homopolymers and/or the copolymers of item 2) and an elastomeric moiety made from or containing one or more of the copolymers of item 4).

In some embodiments, the crystalline propylene homopolymers are isotactic or mainly isotactic homopolymers. In some embodiments, the α-olefins are selected from the group consisting of 1-butene, 1-hexene, 4-methyl-1-pentene, and 1-octene. In some embodiments, the crystalline ethylene polymer is HDPE. In some embodiments, the diene is selected from the group consisting of butadiene, 1,4-hexadiene, 1,5-hexadiene, and ethylidene-1-norbornene. In some embodiments, the diene content is from 1 to 10% by weight. In some embodiments, the thermoplastic elastomeric polyolefin compositions are prepared by mixing the components in the molten state or by sequential polymerization. In some embodiments, the thermoplastic elastomeric polyolefin compositions contain the elastomeric moiety in quantities from 5 to 80% by weight.

In some embodiments, the thermoplastic polyolefin composition is produced by mixing the heterophasic copolymer and the additional polyolefin(s), extruding the mixture, and pelletizing the resulting composition.

In some embodiments, the thermoplastic polyolefin composition is further made from or containing additives. In some embodiments, the additives are selected from the group consisting of mineral fillers, colorants, and stabilizers. In some embodiments, the mineral fillers are selected from the group consisting of talc, CaCO₃, silica, clays, diatomaceaous earth, titanium oxide, and zeolites. In some embodiments, the silica is wollastonite (CaSiO₃). In some embodiments, the mineral filler is in particle form having an average diameter ranging from 0.1 to 5 micrometers.

In some embodiments, the present disclosure provides a thermoplastic polyolefin composition made from or containing:
up to 30% by weight, alternatively from 8% to 25% by weight, alternatively from 10 to 20% by weight, based on the weight of the thermoplastic polyolefin composition, of the heterophasic copolymer, and
at least 70% by weight, alternatively from 92% to 75% by weight, based on the weight of the thermoplastic polyolefin composition of a polyolefin selected from:
1) crystalline propylene homopolymers;
2) crystalline propylene copolymers with ethylene and/or a C₄-C₁₀ α-olefin, wherein the total comonomer content ranges from 0.05 to 20% by weight with respect to the weight of the copolymer;
3) crystalline ethylene homopolymers and copolymers with propylene and/or a C₄-C₁₀ α-olefin;
4) elastomeric copolymers of ethylene with propylene and/or a C₄-C₁₀ α-olefins, optionally containing minor quantities of a diene;
5) thermoplastic elastomeric polyolefin compositions made from or containing one or more of propylene homopolymers and/or the copolymers of item 2) and an elastomeric moiety made from or containing one or more of the copolymers of item 4),
   wherein the weight of the thermoplastic polyolefin composition equals 100. In some embodiments, the crystalline propylene homopolymers are isotactic or mainly isotactic homopolymers. In some embodiments, the α-olefins are selected from the group consisting of 1-butene, 1-hexene, 4-methyl-1-pentene, and 1-octene. In some embodiments, the crystalline ethylene polymer is HDPE. In some embodiments, the diene is selected from the group consisting of butadiene, 1,4-hexadiene, 1,5-hexadiene, and ethylidene-1-norbornene. In some embodiments, the diene content is from 1 to 10% by weight. In some embodiments, the thermoplastic elastomeric polyolefin compositions are prepared by mixing the components in the molten state or by sequential polymerization. In some embodiments, the thermoplastic elastomeric polyolefin compositions contain the elastomeric moiety in quantities from 5 to 80% by weight.

A method for reducing the tiger stripes (or flow marks) in injection-molded articles including preparing articles made from or containing the heterophasic copolymer or the thermoplastic polyolefin composition.

In some embodiments, the present disclosure provides articles made from or containing the thermoplastic polyolefin composition. In some embodiments, the articles are automotive parts. In some embodiments, the automotive parts are selected from the group consisting of bumpers and fascia.

The following examples are illustrative and not intended to limit the scope of the disclosure in any manner whatsoever.

The following analytical methods are used to characterize the heterophasic copolymers and the thermoplastic polyolefin compositions.

### EXAMPLES

### Characterizations

Melt Flow Rate: Measured according to ISO 1133 (230° C., 2.16 kg load).

Intrinsic viscosity [η]: The sample was dissolved in tetrahydronaphthalene at 135° C. and then poured into a capillary viscometer. The viscometer tube (Ubbelohde type) was surrounded by a cylindrical glass jacket; this setup allowed for temperature control with a circulating thermostatic liquid. The downward passage of the meniscus was timed by a photoelectric device. The passage of the meniscus in front of the upper lamp started the counter which had a quartz crystal oscillator. The counter stopped as the meniscus passed the lower lamp. The efflux time was registered and converted into a value of intrinsic viscosity through Huggins' equation (Huggins, M. L., J. Am. Chem. Soc., 1942, 64, 2716), using the flow time of the pure solvent at the same experimental conditions (same viscometer and same temperature). A single polymer solution was used to determine [η].

Ethylene and 1-Butene content: The spectrum of a pressed film of the polymer was recorded in absorbance vs. wavenumbers (cm-1). The following measurements were used to calculate ethylene and 1-butene content:
Area (At) of the combination absorption bands between 4482 and 3950 cm-1 which was used for spectrometric normalization of film thickness.
Area (AC2) of the absorption band between 750-700 cm-1 after two proper consecutive spectroscopic subtractions of an isotactic PP spectrum and then of a standard spectrum obtained from a polypropylene modified with 1-butene, were measured to determine ethylene content.
Height (DC4) of the absorption band at 769 cm-1 (maximum value), after two proper consecutive spectroscopic subtractions of the isotactic PP spectrum (IPPR) and then of a standard spectrum obtained from a polypropylene modified with ethylene, were measured to determine 1-butene content.
   This method was calibrated by using 13C NMR standards.

Melting temperature (ISO 11357-3): Determined by differential scanning calorimetry (DSC). A sample weighing 6±1 mg, was heated to 200±1° C. at a rate of 20° C./min and kept at 200±1° C. for 2 minutes in nitrogen stream. The sample was then cooled at a rate of 20° C./min to 40±2° C., then kept at this temperature for 2 min to allow crystallization of the sample. Then, the sample was fused at a temperature rise rate of 20° C./min up to 200° C.±1. The melting scan was recorded. A thermogram was obtained (° C. vs. mW). The temperatures corresponding to peaks were read. The temperatures corresponding to the most intense melting peaks recorded during the second fusion were taken as the melting temperatures.

Xylene soluble fraction (XS): 2.5 g of polymer and 250 cm³ of xylene were introduced into a glass flask equipped with a refrigerator and a magnetic stirrer. The temperature was raised in 30 minutes up to the boiling point of the solvent. The resulting clear solution was then kept under reflux and stirring for further 30 minutes. The closed flask was then kept for 30 minutes in a bath of ice and water and then in a thermostatic water bath at 25° C. for 30 minutes. The resulting solid was filtered on quick filtering paper. 100 cm³ of the filtered liquid were poured into a pre-weighed aluminum container, which was heated on a heating plate under nitrogen flow, thereby removing the solvent by evaporation. The container was then kept in an oven at 80° C. under vacuum until a constant weight was obtained. The weight percentage of polymer soluble in xylene at room temperature was then calculated.

Tensile properties (Tensile Modulus, Strength and elongation at yield, and Strength and elongation at break): Measured according to according to ISO 178 on multipurpose bars molded at 23° C. in line with EN ISO 20753 Type A1.

Charpy notched impact: Measured according to ISO 179/1eA at +23° C., 0° C., −20° C. and −30° C. using a specimen 80×10×4 mm, which was prepared from injection-molded multipurpose bars molded at 23° C. in line with EN ISO 20753 Type A1.

Vicat: measured according to ISO 306 using an injection-molded specimen 80×10×4 mm, which was prepared from injection-molded multipurpose bars molded at 23° C. in line with EN ISO 20753 Type A1.

Ashes content: Measured according to ISO 3451/1.

Gloss: Measured according to ISO 2813 on an injected-molded plaque 145 X 207 X3 mm with grain Opel N127 and Opel N111.

Scratch resistance: Measured according to GMW14688—Method A on an injected-molded plaque 145 X 207 X3 mm with grain Opel N127 and Opel N111.

Post molding Longitudinal and transversal thermal shrinkage: A plaque of 100 × 195 × 2.5 mm was molded in an injection-molding machine Krauss Maffei KM250/1000C2 250 tons of clamping force. The injection conditions were:
melt temperature=220° C.
mold temperature=35° C.;
injection time=3,6 s
holding time=30 seconds
screw diameter=55 mm
   The plaque was measured 48 hours after molding, through calipers, and the shrinkage was given by:

Longitudinal shrinkage=((195−read_value)/195)×100

Transversal shrinkage=((100−read_value)/100)×100

wherein 195 is the length (in mm) of the plaque along the flow direction, measured immediately after molding; 100 is the length (in mm) of the plaque crosswise the flow direction, measured immediately after molding; the read value was the plaque length in the relevant direction.

Tiger Stripes ratio: The tiger stripes ratio was calculated, after injecting molten polymer into the center of a hollow spiral mold. The ratio was expressed by the distance between the injection point and the first stripe visible in the solidified polymer, divided by the total length of the spiral of solidified polymer. PII % and PIII % refer to tests done at 10 and 15 mm/s as injection speed, respectively. The evaluation was carried out visually on the spirals made with an injection molding process with a Krauss-Maffei KM250/1000C₂ machine working under the following conditions:
Melt Temperature: 230° C.
Mold Temperature: 50° C.
Average Injection Speed: 10 and 15 mm/s
Change-over Pressure Set: 100 bar
Holding Pressure (hydraulic): 28 bar
Holding Pressure Time: 15 s
Cooling Time: 20 s
Thickness of the spiral 2.0 mm
Width of the spiral 50.0 mm
Clamping force: 2500 kN

### Example 1

### Preparation of the Solid Catalyst Component

Into a 500 mL four-necked round flask, purged with nitrogen, 250 mL of TiCl₄ were introduced at 0° C. While stirring, 10.0 g of microspheroidal MgCl₂·2.8C₂H₅OH (prepared according to the method described in Example 2 of U.S. Pat. No. 4,399,054 but operating at 3000 rpm instead of 10000 rpm) and 7.4 mmol of diethyl 2,3-diisopropylsuccinate were added. The temperature was raised to 100° C. and maintained for 120 min. Then, the stirring was discontinued. The solid product was allowed to settle. The supernatant liquid was siphoned off. Then 250 mL of fresh TiCl₄ were added. The mixture reacted at 120° C. for 60 min. Then, the supernatant liquid was siphoned off. The solid was washed six times with anhydrous hexane (6×100 mL) at 60° C.

### Preparation of the Catalyst System and Prepolymerization Treatment

Before introducing the solid catalyst component into the polymerization reactors, the solid catalyst component was contacted at 18° C. for 8-9 minutes with aluminum triethyl (TEAL) and dicyclopentyldimethoxysilane (DCPMS) in a quantity such that the weight ratio of TEAL to the solid catalyst component was equal to 4.2, and the weight ratio TEAL/DCPMS was equal to 5.1. The resulting catalyst system was then subjected to prepolymerization by suspending the catalyst system in liquid propylene at 20° C. for about 30 minutes before introducing the catalyst system into the first polymerization reactor.

### Polymerization

The heterophasic copolymer was prepared with a polymerization process conducted in continuous mode in a series of two fluidized-bed gas-phase reactors equipped with devices to transfer the product from the first reactor to the second reactor. Component (A) was prepared in the first reactor, while component (B) was prepared in the second reactor. Into the first gas phase reactor, a propylene/butene-1 copolymer [component (A)] was produced by feeding the prepolymerized catalyst system, hydrogen (used as a molecular weight regulator), propylene, and butene-1, in the gas state in a continuous and constant flow, according to the conditions reported in Table 1. The component (A) coming from the first reactor was discharged in a continuous flow and, after having been purged of unreacted monomers, was introduced, in a continuous flow, into the second gas phase reactor, together with quantitatively constant flows of hydrogen and ethylene, in the gas state, wherein a propylene/ethylene copolymer [component (B)] was produced. The polymer particles exiting the final reactor were subjected to a steam treatment, thereby removing the reactive monomers and volatile substances, and then dried. The resulting heterophasic copolymer was subject to mechanical characterization, the results of which are reported in Table 2.

### Example 2

The same solid catalyst component described in example 1 was used. The catalyst system was prepared and prepolymerized as described in example 1, except that the weight ratio of TEAL to the solid catalyst component was equal to 3.7, and the weight ratio TEAL/DCPMS was equal to 5.0. The polymerization was conducted as described in example 1, except that component (A) was prepared in two sequential fluidized-bed gas-phase reactors. Component (B) was prepared in a third fluidized-bed gas-phase reactor. Mechanical characterization of the resulting heterophasic copolymer is reported in Table 2.

### Comparative Example 1 (CE1)

The heterophasic copolymer CM688A, commercially available from Sun Allomer, was used as Comparative Example 1. Comparative Example 1's mechanical characterization is reported in Table 2.

### Examples 3-6 and Comparative Examples 2-3 (CE2 and CE3)

The tiger stripes of the heterophasic copolymers obtained in Examples 1 and 2 and of CE1 were evaluated with formulations obtained by mixing, in an internal mixer, a certain amount of the heterophasic copolymers with the other components shown in Tables 3 and 4 respectively. The results are reported in Table 5.

TABLE 1

| | | |
|---|---|---|
| Process conditions | Ex. 1 | Ex. 2 |

1^{st} Gas-phase polymerization

| | | |
|---|---|---|
| T (° C.) | 75 | 70 |
| Pressure (barg) | 18 | 18 |
| Residence time (min) | 56 | 81 |
| H₂ (mol %) | 4.2 | 6.5 |
| Propylene (mol %) | 41.2 | 22.4 |
| Butene-1 (mol %) | 1.5 | 1.0 |
| Propane (mol %) | 53.3 | 71.6 |
| Split (%) | 59 | 29 |
| MFR (g/10 min) | 105 | 328 |
| Butene-1 (wt %) | 1.2 | 1.4 |
| XS (%) | 3.5 | 4.4 |

2^{nd} Gas-phase polymerization

| | | |
|---|---|---|
| T (° C.) | none | 80 |
| Pressure (barg) | none | 18 |
| Residence time (min) | none | 111 |
| H₂ (mol %) | none | 2.6 |
| Propylene (mol %) | none | 67.4 |
| Butene-1 (mol %) | none | 2.9 |
| Propane (mol %) | none | 27.3 |
| Split (%) | none | 41 |
| MFR (g/10 min) | none | 108 |
| Butene-1 (wt %) | none | 1.4 |
| XS (%) | none | 3.5 |

Gas-phase copolymerization

| | | |
|---|---|---|
| T (° C.) | 60 | 66 |
| Pressure (barg) | 16 | 18 |
| Residence time (min) | 130 | 107 |
| H₂ (mol %) | 0 | 0.1 |
| Ethylene (mol %) | 3.3 | 12.3 |
| Propylene (mol %) | 15.5 | 58.7 |
| Propane (mol %) | 81.5 | 28.1 |
| Split (%) | 41 | 30 |
| Ethylene in copolymer (wt %) | 30.0 | 33.5 |

TABLE 2

| Heterophasic copolymer | Ex. 1 | Ex. 2 | CE 1 |
|---|---|---|---|
| MFR (g/10 min) | 5.5 | 9.5 | 8.5 |
| Ethylene total (wt %) | 10.9 | 10.4 | 8.5 |
| Butene-1 total (wt %) | 1.2 | 1.3 | 0 |
| XS | 34.2 | 30.0 | 23.6 |
| XS-IV | 6.74 | 6.73 | 6.89 |
| Melting temperature (° C.) | 155.1 | 155.0 | 161.0 |
| Charpy 23° C. (KJ/m²) | 83.4 | 51.4 | 15.3 |
| Charpy 0° C. (KJ/m²) | 8.4 | 6.3 | 6.0 |
| Charpy −20° C. (KJ/m2) | 4.0 | 3.9 | 3.8 |

TABLE 3

| Injection molding composition (% weight) | Ex. 3 | Ex. 4 | CE2 |
|---|---|---|---|
| Heterophasic copolymer Ex. 1 | 8.5 | 0 | 0 |
| Heterophasic copolymer Ex. 2 | 0 | 8.5 | 0 |
| Heterophasic copolymer CE1 | 0 | 0 | 8.5 |
| Metocene MF650Y | 22.5 | 22.5 | 22.5 |
| PP homopolymer PMB02A (Sun Allomer) | 17.5 | 17.5 | 17.5 |
| Moplen HF501N | 1.95 | 1.95 | 1.95 |
| ENGAGE ™ 8150 | 21.0 | 21.0 | 21.0 |
| KRATON ™ G1657 | 4.0 | 4.0 | 4.0 |
| Talk Luzenac Jetfine 3CA | 22.0 | 22.0 | 22.0 |
| Irganox 1010 FF | 0.1 | 0.1 | 0.1 |
| Irgafos 168 | 0.1 | 0.1 | 0.1 |
| Dimodan HP PEL-1 | 0.4 | 0.4 | 0.4 |
| Calcium Stearat - LIGA CA 860 | 0.05 | 0.05 | 0.05 |
| Chimassorb 944 FDL | 0.1 | 0.1 | 0.1 |
| Magnesium Stearat (STOCKBRIDGE) | 0.2 | 0.2 | 0.2 |
| ADK STAB NA 11 UH | 0.2 | 0.2 | 0.2 |
| Tinuvin 770 DF | 0.3 | 0.3 | 0.3 |
| Tinuvin 120 | 0.1 | 0.1 | 0.1 |
| BK MB - PP MB 40% Black | 1.0 | 1.0 | 1.0 |

TABLE 4

| Injection molding composition (% weight) | Ex. 5 | Ex. 6 | CE3 |
|---|---|---|---|
| Heterophasic copolymer Ex. 1 | 11.0 | 0 | 0 |
| Heterophasic copolymer Ex. 2 | 0 | 11.0 | 0 |
| Heterophasic copolymer CE1 | 0 | 0 | 11.0 |
| Moplen EP500V | 25.0 | 25.0 | 25.0 |
| Hostalen GC7260 | 5.0 | 5.0 | 5.0 |
| Adstif EA600P | 25.3 | 25.3 | 25.3 |
| Moplen HF501N | 1.52 | 1.52 | 1.52 |
| ENGAGE ™ 7467 | 10.0 | 10.0 | 10.0 |
| Talk Imerys Steamic T1 CA | 15.0 | 15.0 | 15.0 |
| Irganox 1010 FF | 0.2 | 0.2 | 0.2 |
| Irgafos 168 | 0.2 | 0.2 | 0.2 |
| Dimodan HP PEL-1 | 0.15 | 0.15 | 0.15 |
| CYASORB UV-3853 S | 0.10 | 0.10 | 0.10 |
| Licowax OP POWDER | 0.10 | 0.10 | 0.10 |
| Dow Corning Silicone MB 50-001 MP | 2.00 | 2.00 | 2.00 |
| Magnesium Oxid (MG OXIDE - REMAG AC) | 0.15 | 0.15 | 0.15 |
| YL PI - Sicotan Yellow K2001 FG | 0.21 | 0.21 | 0.21 |
| WT PI - Kronos 2220 | 0.64 | 0.64 | 0.64 |
| BL PI - Ultramarine Blue E-78LD | 1.16 | 1.16 | 1.16 |
| RD MB - Eupolen PE Red 47-9001 | 0.07 | 0.07 | 0.07 |
| BK MB - PP MB 40% Black | 2.2 | 2.2 | 2.2 |

TABLE 5

| Properties | Ex. 3 | | Ex. 4 | | CE2 | | Ex. 5 | | Ex. 6 | | CE3 | |
|---|---|---|---|---|---|---|---|---|---|---|---|---|
| Tigerstripes PII (%) | 58 | | 57 | | 53 | | 95 | | 91 | | 82 | |
| Tigerstripes PIII (%) | 80 | | 72 | | 69 | | 100 | | 96 | | 88 | |
| MFR (g/10 min) | 39.9 | | 41.5 | | 42.1 | | 14.6 | | 16.0 | | 16.6 | |
| Ash content 1 h, 625° C. | 26.7 | | 26.1 | | 25.3 | | 18.7 | | 19.6 | | 19.1 | |
| (%) | | | | | | | | | | | | |
| Tensile Modulus | 2291 | | 2342 | | 2346 | | 1779 | | 1818 | | 1882 | |
| (N/mm²) | | | | | | | | | | | | |
| Tensile Stress at yield | 20.6 | | 20.8 | | 20.9 | | n.a. | | n.a. | | n.a. | |
| (N/mm²) | | | | | | | | | | | | |
| Elongation at yield (%) | 4.2 | | 3.8 | | 3.7 | | n.a. | | n.a. | | n.a. | |
| Tensile stress at break | 13.3 | | 12.2 | | 11.9 | | n.a. | | n.a. | | n.a. | |
| (N/mm²) | | | | | | | | | | | | |
| Elongation at break (%) | 92 | | 81.7 | | 72 | | n.a. | | n.a. | | n.a. | |
| Charpy Notched | 49.5 | D | 46.5 | D | 46.2 | D | 24.7 | B | 18.8 | B | 15.9 | B |
| Impact 23° C. (kJ/m²) | | | | | | | | | | | | |
| Charpy Notched | 19.2 | B | 12.8 | B | 17.4 | B | 6.79 | B B | 6.24 | B | 5.88 | B |
| Impact 0° C. (kJ/m²) | | | | | | | | | | | | |
| Charpy Notched | 4.21 | B | 3.87 | B | 4.11 | B | 3.28 | B | 3.43 | B | 3.17 | B |
| Impact −30° C. (kJ/m²) | | | | | | | | | | | | |

| | | | | | | |
|---|---|---|---|---|---|---|
| Vicat softening point A | 128 | 128 | 128 | n.a. | n.a. | n.a. |
| (10N) (° C.) | | | | | | |
| Mold shrinkage | 0.39/0.63 | 0.39/0.62 | 0.40/0.64 | 0.70/0.98 | 0.70/0.97 | 0.75/1.04 |
| Long/Transv (%) | | | | | | |
| Gloss 60°, N127 (G) | 1.9 | 1.8 | 1.8 | 1.8 | 1.9 | 1.8 |
| Gloss 60°, N111 (G) | 4 | 4 | 4 | 3.9 | 3.9 | 3.8 |
| Scratch resistance | 7.2 | 7.4 | 7.1 | 0.7 | 1.0 | 1.0 |
| (10N), N127 (dL) | | | | | | |
| Scratch resistance | 5.8 | 5.8 | 5.6 | 0.3 | 0.4 | 0.5 |
| (10N), N111 (dL) | | | | | | |

1. A heterophasic copolymer comprising:
(a) from 55 to 75 wt. %, based on the total weight of the heterophasic copolymer, of a component (A), wherein component (A) is a copolymer of: (1) propylene and (2) ethylene or an alpha-olefin having 4-10 carbon atoms, and wherein component (A) comprises from 0.5 to 2.0 wt. %, based on the total weight of component (A), of units of ethylene and/or of C₄-C₁₀ alpha-olefin and has a MFR₂ (230° C./2.16 Kg) ranging from 60 to 140 g/10 min.; and
(b) from 25 to 45 wt. %, based on the total weight of the heterophasic copolymer, of a component (B), wherein component (B) is a propylene-ethylene copolymer, and wherein component (B) comprises from 25 to 45 wt. %, based on the total weight of component (B), of ethylene units and contains a fraction that is soluble in xylene at room temperature, and wherein the fraction that is soluble in xylene at room temperature has an intrinsic viscosity (XS-IV) ranging from 5 to 9 dl/g;
wherein the percentages of components (A) and (B) are referred to the sum of components (A) and (B) and wherein the sum of components (A) and (B) equals 100;
wherein the heterophasic copolymer has a MFR₂ (230° C./2.16 Kg) ranging from 3.0 to 12.0 g/10 min.

2. The heterophasic copolymer according to claim 1, wherein the amount of component (A) ranges from 58 to 71 wt. %, based on the total weight of the heterophasic copolymer.

3. The heterophasic copolymer according to claim 1, wherein the comonomer of component (A) is butene-1.

4. The heterophasic copolymer according to claim 3, wherein the butene-1 content ranges from 1.0 to 1.5 wt. %, based on the total weight of component (A).

5. The heterophasic copolymer according to claim 1, wherein the MFR₂ (230° C./2.16 Kg) of component (A) ranges from 80 to 120 g/10 min.

6. The heterophasic copolymer according to claim 1, wherein component (B) is present in an amount ranging from 29 to 42 wt. %, based on the total weight of the heterophasic copolymer.

7. The heterophasic copolymer according to claim 1, wherein the content of ethylene units in component (B) ranges from 28 to 35 wt. %, based on the total weight of component (B).

8. The heterophasic copolymer according to claim 1, wherein the intrinsic viscosity of the fraction soluble in xylene at room temperature (XS-IV) for component (B) ranges from 6 to 8 dl/g.

9. The heterophasic copolymer according to claim 1, having a value of Charpy impact resistance at 23° C. ranging from 40 to 100 KJ/m2.

10. The heterophasic copolymer according to claim 1, having a value of Charpy impact resistance at −20° C. ranging from 3.0 to 5.0 KJ/m2.

11. A thermoplastic polyolefin composition comprising the heterophasic copolymer of claim 1.

12. The thermoplastic polyolefin composition according to claim 11, wherein the amount of heterophasic copolymer is up to 30% by weight.

13. An article comprising the thermoplastic polyolefin composition of claim 11.

14. The article according to claim 13, being an automotive part.
